(19) United States
(12) Patent Application Publication
(10) Pub. No.: US 2016/0163211 A1
(43) Pub. Date: Jun. 9, 2016

(54) ACCESSIBLE CONTENT PUBLISHING ENGINE

(71) Applicant: Pearson Education, Inc., New York, NY (US)

(72) Inventors: Hua Tang Piper, Longwood, FL (US); Russell Ian Lewinter, Orlando, FL (US)

(21) Appl. No.: 14/985,097

(22) Filed: Dec. 30, 2015

Related U.S. Application Data
(63) Continuation-in-part of application No. 14/280,411, filed on May 16, 2014.
(60) Provisional application No. 61/824,259, filed on May 16, 2013.

(51) Int. Cl. G09B 5/06

(52) U.S. Cl. CPC G09B 5/065

(57) ABSTRACT

The techniques disclosed teach automatically generating educational course material according to presentation rules. A course model creation engine retrieves course objectives, course outlines, and the mapping of those to each other to create a course model. A course component creation engine retrieves course content and presentation rules to create the course components. A publication engine published the course material in compliance with the presentation rules.

### CROSS-REFERENCES TO RELATED APPLICATIONS

The present application claims benefit of U.S. application Ser. No. 14/280411, entitled “INSTRUCTIONAL DESIGN AND DEVELOPMENT INTERFACE,” filed on May 16, 2014, of which the entire disclosure is incorporated herein by reference for all purposes. U.S. application Ser. No. 14/280411 claims benefit under 35 USC 119(e) of U.S. Provisional Application No. 61/824259 filed on May 16, 2013, and entitled “INSTRUCTIONAL DESIGN AND DEVELOPMENT INTERFACE,” of which the entire disclosure is incorporated herein by reference for all purposes.

### BACKGROUND OF THE INVENTION

Manually creating educational courses with a multitude of presentation formats for learners is time-consuming and difficult. Thus, there is a need to automatically create educational courses that are presented to learners according to presentation rules. For instance there is a need to present courses that are accessible to learners who are audibly or visually impaired. There is also a need to present courses in different language and that comply with laws and customs in different countries. Further—some learners may prefer to listen to courses while others may prefer to read and watch it quietly.

### BRIEF SUMMARY OF THE INVENTION

A method of electronically creating a digital education course in compliance with presentation rules is one embodiment of the invention. The method comprises the following steps. A step of the method is receiving the presentation rules from user devices, and another step is receiving course components from the user devices. Additional steps are determining there is a still image within the course components, causing a still image template to appear on the user devices, retrieving a first textual description of the still image from the still image template, and associating the first textual description of the still image with the still image. Other steps are determining there is a video image within the course components, causing a video image template to appear on the user devices, retrieving a second textural description of the video image from the video image template, retrieving textual captions from the video image template, and associating the second textural description and the textual captions with the video image. Further steps are determining there is a simulation within the course components, causing a simulation template to appear on the user devices, retrieving a third textural description of the simulation from the simulation template, and associating the third textural description of the simulation with the simulation. Yet additional steps are transforming the course components to create lesson content using the presentation rules, causing a publication template to appear on the user devices, retrieving from the publication template a publication selection to publish the lesson content in accordance the presentation rules, and publishing the lesson content in accordance with the presentation rules.

In another embodiment, the present disclosure provides a processor with computer-readable medium having executable instructions for electronically creating a digital education course in compliance with presentation rules, the processor comprising executable instructions for causing actions. Two such actions are receiving the presentation rules from user devices and receiving course components from the user devices. Other actions are determining there is a still image within the course components, causing a still image template to appear on the user devices, retrieving a first textual description of the still image from the still image template, and associating the first textural description of the still image with the still image. Additional actions are determining there is a video image within the course components, causing a video image template to appear on the user devices, retrieving a second textual description of the video image from the video image template, retrieving textual captions for the video image from the video image template, and associating the second textural description of the video image and the textual captions of the video image with the video image. Additional actions are determining there is a simulation within the course components, causing a simulation template to appear on the user devices, retrieving a third textual description of the simulation from the simulation template, and associating the third textural description of the simulation with the simulation. Yet other actions are transforming the course components to create lesson content using the presentation rules causing a publication template to appear on the user devices retrieving from the publication template a publication selection to publish the lesson content in accordance with the presentation rules; and publishing the lesson content in accordance with the presentation rules

In yet another embodiment, the present disclosure provides a system for electronically creating a digital education course in compliance with presentation rules, the system configured to achieve results. Two such results are to receive the presentation rules from a user device and to receive course components from the user devices. Other results are to determine there is a still image within the course components, cause a still image template to appear on the user devices, retrieve a first textual description of the still image from the still image template, and associate the first textural description of the still image with the still image. Additional results are to determine there is a video image within the course components, cause a video image template to appear on the user devices, retrieve a second textual description of the video image from the video image template, retrieve textual captions for the video image from the video image template, and associate the second textural description of the video image and the textual captions of the video image with the video image. Further results are to determine there is a simulation within the course components, cause a simulation template to appear on the user devices, retrieve a third textual description of the simulation from the simulation template, and associate the third textural description of the simulation with the simulation. Yet other results are to transform the course components to create lesson content using the presentation rules; cause a publication template to appear on the user devices; retrieve from the publication template a publication selection to publish the lesson content in accordance with the presentation rules; and publish the lesson content in accordance with the presentation rules.

Further areas of applicability of the present disclosure will become apparent from the detailed description provided hereinafter. It should be understood that the detailed description and specific examples, while indicating various embodiments, are intended for purposes of illustration only and are not intended to necessarily limit the scope of the disclosure.

### BRIEF DESCRIPTION OF THE DRAWINGS

The present disclosure is described in conjunction with the appended figures:

FIG. 1 shows an embodiment of a course creation interaction diagram for interactively developing and using an educational course

FIG. 2 shows a block diagram of an integrated course design and development system.

FIG. 3 shows a block diagram illustrating a sequence of levels for educational course development, according to an embodiment.

FIG. 4 is a flow chart illustrating steps for interactively developing an educational course, according to an embodiment.

FIG. 5 is a flowchart of creating and publishing lesson content according to presentation rules.

FIG. 6 shows templates used to automatically create lesson content.

FIG. 7 shows an example screen shot of a still image template.

FIGS. 8A and 8B shows an example screen shot of a video image template.

FIGS. 9A and 9B shows an example screen shot of a simulation template.

FIG. 10 shows an example screen shot of a publication template.

FIG. 11 illustrates a computer system.

In the appended figures, similar components and/or features may have the same reference label. Further, various components of the same type may be distinguished by following the reference label by a dash and a second label that distinguishes among the similar components. If only the first reference label is used in the specification, the description is applicable to any one of the similar components having the same first reference label irrespective of the second reference label.

### DETAILED DESCRIPTION OF THE INVENTION

The ensuing description provides preferred exemplary embodiment(s) only, and is not intended to limit the scope, applicability or configuration of the disclosure. Rather, the ensuing description of the preferred exemplary embodiment(s) will provide those skilled in the art with an enabling description for implementing a preferred exemplary embodiment. It is understood that various changes may be made in the function and arrangement of elements without departing from the spirit and scope as set forth in the appended claims.

The present disclosure is directed to methods, systems, and devices for automatically creating and publishing educational course material based on presentations rules. The course provider selects the course presentation rules, and the system automatically applies them to the course. The course developers do not need to know the presentation rules even though the presentation rules dictate the audible and visual presentation of the course to the learner. The presentation rules may be accessibility rules such as those found in Section 508 of the Rehabilitation Act of 1973 as amended in 1998 (29 U.S.C. Section 794(d)) (“Section 508”). The presentation rules may also be rules relating to the language used in the presentation or any other visual or audio presentation factor. The ensuing description provides preferred exemplary embodiment(s) only, and is not intended to limit the scope, applicability or configuration of the disclosure. Rather, the ensuing description of the preferred exemplary embodiments(s) will provide those skilled in the art with an enabling description for implementing the preferred exemplary embodiment.

In one embodiment, the system for automatically creating and developing educational courses according to presentation rules receives inputs from a variety of users and sources such as subject matter experts, instructional designers, digital libraries, authors, administrators, course instructors, media experts, and editors, among others. The system allows a team of course developers to work concurrently and collaboratively from many geographic locations to input the necessary data over a network to the course providers server to create courses. The structured interactive interface allows the system to maintain transparency and version control while the course developers are developing, inputting, editing, and reviewing course data.

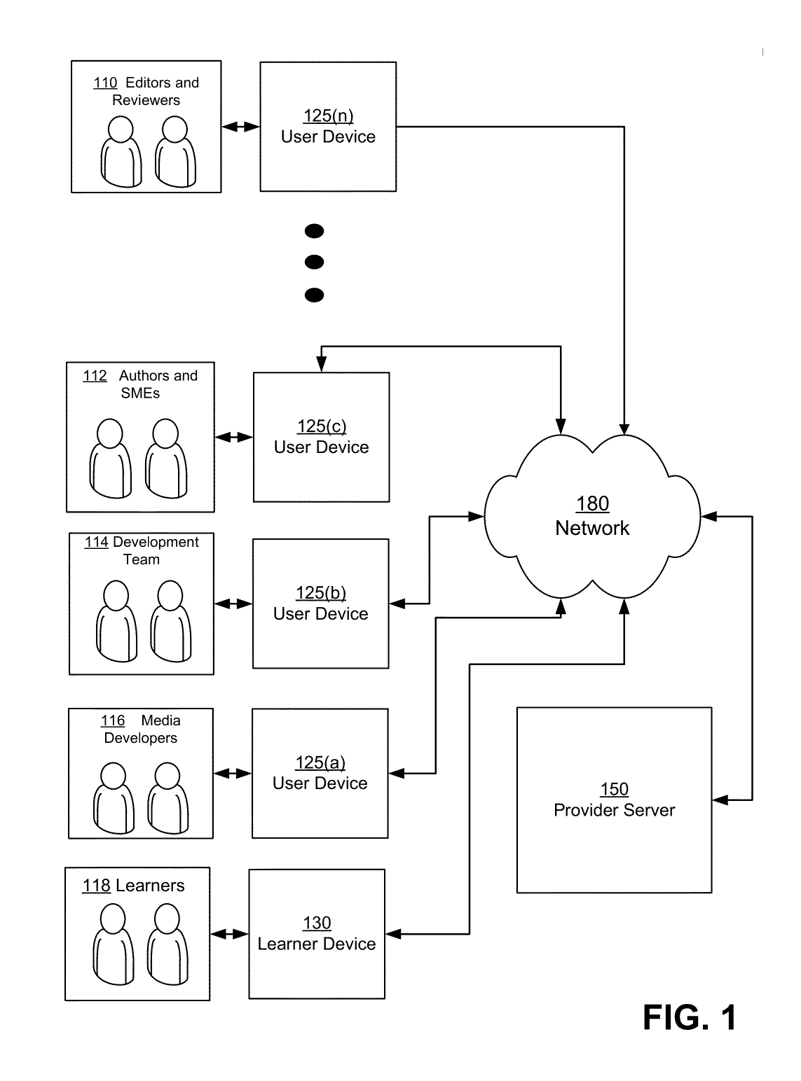

FIG. 1 shows an embodiment of a course creation interaction diagram for interactively developing and using an educational course. Typically multiple users or user groups contribute or modify course content by interacting with user devices 125 through a network 180 to a provider server 150. As used herein the term ‘user’ may denote either a single person or a group of persons contributing to the course development of the course. The terms ‘user group,’ ‘course creator’ or ‘educator’ may denote either a single person or a group of persons contributing to the development of the course. The user devices 125 can be any number of devices capable of interacting over the network 180 to the provider server 150 including, but not limited to, a desktop computer, laptop, tablet, smart phone, or any other computing device. The network 180 is any network that allows the user devices 125 to communicate with the provider server 150 such as a local area network, intranet, internet, WiFi, Bluetooth, cellular, or any other wired or wireless connection.

Multiple users may contribute to developing an educational course where each user may be simultaneously contributing to the part of the course development that is in their area of expertise. The course provider my designate a particular user that will dictate the presentation rules or, in other embodiments, any user can establish the presentation rules. One user or user group may comprise subject matter experts 112 tasked with providing the basic content of the course. Such users may comprise lecturers or instructors who conduct the class, authors who compose lectures or presentations, or experts who produce supplemental explanatory material. For example, one subject matter expert 112 may be a biologist who will generate lessons or lectures for an introductory zoology course. Another subject matter expert 112 may be an entomologist tasked with providing supplemental reading material related to the specialized subject of insect zoology. Subject matter experts 112 input information with user devices 125.

Another user or user group may comprise media developers 116 who are tasked with producing or obtaining visual or audio materials. For example, such materials may comprise still photos, video clips or sound recordings that are related to the subject matter of a lesson. Such media may enhance and clarify the subject matter being presented in particular lessons. Media developers 116 may also be tasked with developing user interfaces by which students may access course materials, and may interact with the course. For example, secure user interfaces may be created by the media developers for student testing or assessment. Media developer 116 input media of all types for the course being developed with user devices 125.

Another user may comprise editors and reviewers 110 that check and oversee course content submitted either by the subject matter experts 112 or the media developers 116. One such task, for instance, is ensuring the course content follows the overall plan for the course. Editors and reviewers 110 access and input content with user devices 125.

Another user may be a development team 114 who may initiate course development, provide copyrighted material, maintain one or more computer systems implementing the course creation, and provide other logistical support or assistance to the other users. The development team 114 may perform other tasks as needed to ensure the successful development of the educational course. Development team 114 initiate course development and other functions as appropriate with user devices 125.

The users and user groups discussed above are exemplary only. In other situations there may be more, fewer or different users. Further, the tasks of various users may be combined, or assigned differently.

The learner 118 access the lesson content created by the users with a learner device 130. The learner device 130 can be any number of devices capable of interacting over the network 180 to the provider server 150 including, but not limited to, a desktop computer, laptop, tablet, smart phone, or any other computing device. The network 180 is any network that allows the learner device 130 to communicate with the provider server 150 such as a local area network, intranet, internet, WiFi, Bluetooth, cellular, or any other wired or wireless connection.

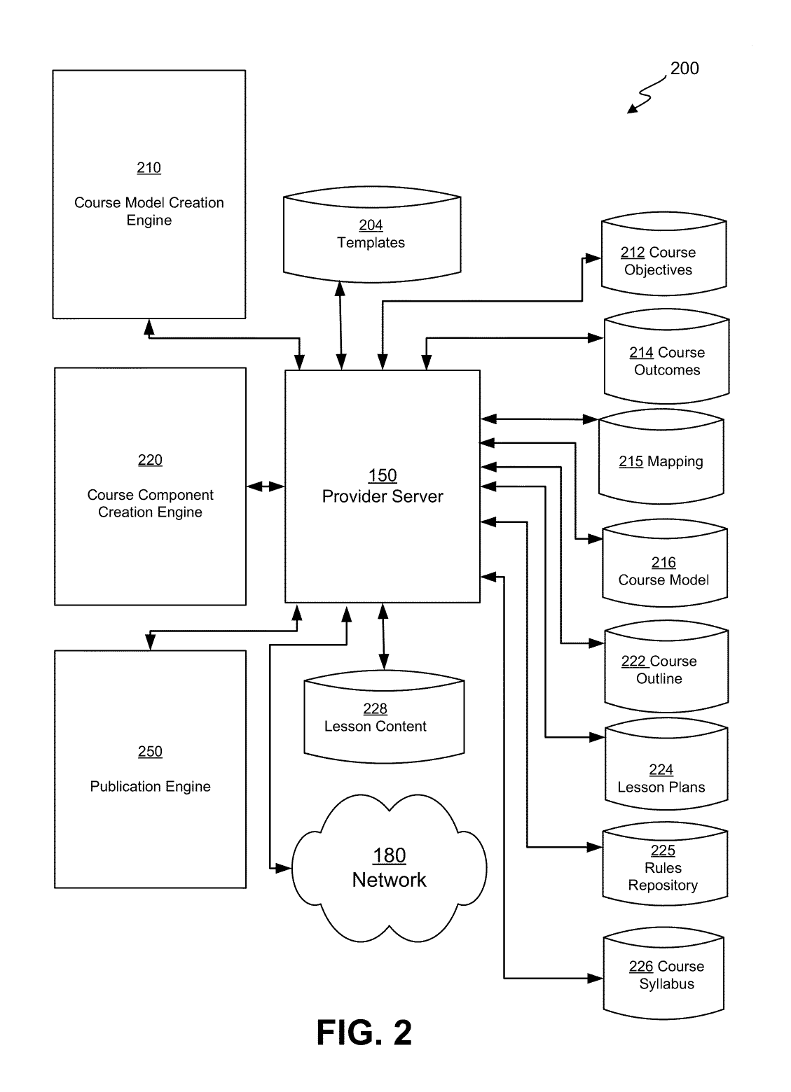

Referring next to FIG. 2, an embodiment of a block diagram of an integrated course design and development system 200 is shown for implementing course design and development. The integrated course design and development system 200 is implemented either directly in electronics hardware or as software implemented using a computer system such as are discussed below. One or more users or educators of the integrated course design and development system 200 interact through course templates 204 over the network 180.

Templates 204 is a template repository for the templates use to automatically create lesson content. The integrated course design and development system 200 presents templates on the user devices 125 that direct users to enter content and defines how it should be entered. A course model creation engine 210 sends course objective template 600, course outcome template 605, and mapping template 610 to user devices 125 for users to input course objectives 212, course outcomes 214, and mapping 215 that maps the relationship between the course objectives 212 and the course outcomes 214. The course model creation engine 210 then creates a course model 216 using the course objectives 212, course outcomes 214, and course mapping 215. The course model 216 is sometimes referred to as a course blueprint for the course under development. In one embodiment, the course model 216 is implemented in a relational database and stores all the information for a particular course including course objectives 212, course outcomes 214, mapping 215, completed templates in templates 204, and any other course information, quiz material, etc.

The course component creation engine 220 presents course content template 615 to users to collect course content. The course component creation engine 220 receives additional information from users through templates in templates 204 to supplement the course model 216. The templates in templates 204 may be partially complete course outline template 600, and templates for lesson plans 224, and course syllabi 226. From the start, templates in templates 204 include the course objectives 212 and course outcomes 214, mapping 215, and also includes other templates to enter content. As the templates are completed, the course model creation engine 210 updates the course model 216.

A rules repository 225 comprises the presentation rules including Section 508 accessibility rules. The rules repository 225 may also include accessibility rules for other countries as well as foreign language rules for many different countries. For instance—the presentation rules could require an output in Spanish, French, German, Arabic, Japanese, Chinese, Russian, or any other language. The rules repository 225 may contain any number of rules or standards that dictate how the outcome of a course is presented to the course user.

Section 508 rules specify that the learning experience for a visually, audibly, or other disabled person be the same as that for anyone else. In one instance a visually impaired learner might use a screen reader that will read the written content of the web page. This requires that the learning material be created to be screen reader accessible—and the pictures, videos, and simulations be properly explained and captioned in text the screen reader can recognize and read. In another instance an audibly impaired learned would need all audio information from still pictures and videos captioned and explained in a textual format. A non-comprehensive list of Section 508 Criteria is listed in the table below.

Criteria

(a) A text equivalent for every non-text element shall be provided (e.g., via “alt”, “longdesc”, or
in element content).
(b) Equivalent alternatives for any multimedia presentation shall be synchronized with the
presentation.
(c) Web pages shall be designed so that all information conveyed with color is also available
without color, for example from context or markup.
(d) Documents shall be organized so they are readable without requiring an associated style
sheet.
(e) Redundant text links shall be provided for each active region of a server-side image map.
(f) Client-side image maps shall be provided instead of server-side image maps except where the
regions cannot be defined with an available geometric shape.
(g) Row and column headers shall be identified for data tables.
(h) Markup shall be used to associate data cells and header cells for data tables that have two or
more logical levels of row or column headers.
(i) Frames shall be titled with text that facilitates frame identification and navigation
(j) Pages shall be designed to avoid causing the screen to flicker with a frequency greater than 2 Hz
and lower than 55 Hz.
(k) A text-only page, with equivalent information or functionality, shall be provided to make a
web site comply with the provisions of this part, when compliance cannot be accomplished in
any other way. The content of the text-only page shall be updated whenever the primary page
changes.
(l) When pages utilize scripting languages to display content, or to create interface elements, the
information provided by the script shall be identified with functional text that can be read by
Assistive Technology.
(m) When a web page requires that an applet, plug-in or other application be present on the
client system to interpret page content, the page must provide a link to a plug-in or applet that
complies with §1194.21(a) through (l).
(n) When electronic forms are designed to be completed on-line, the form shall allow people
using Assistive Technology to access the information, field elements, and functionality required
for completion and submission of the form, including all directions and cues.
(o) A method shall be provided that permits users to skip repetitive navigation links.
(p) When a timed response is required, the user shall be alerted and given sufficient time to
indicate more time is required.

The presentation rules in the rules repository 225 may also be rules based on the desired language used in the presentation. For instance—the presentation rules may require all of the textual and audio output be in Spanish or any other language. In another case a presentation rule may call for the audio output to be silent and textually explained or that the entire course presentation be made audibly for replay on an audio device such as an MP3 or any other digital player. The presentation rules can also conform to laws in a particular country—for instance one that doesn't allow certain still or video images to be viewed. In another instance particular phrases or words might be banned and need to be replaced by appropriate copy.

The course component creation engine 220 produces lesson presentations, course materials, etc. to aid in teaching the course implementing the presentation rules in the rules repository 225. The course developer or other user need not know or even be aware of the presentation rules required for the course. For instance—if the presentation rules require that the course comply with Section 508—the course creation engine 220 will present the user devices 125 with the still image template 620 that directs the user to input a textual description of the still image. So while the user must input the additional information into still image template 620—the user need not know that inputting that information is in compliance with a Section 508 requirement. Furthermore—course component creation engine 220 will automatically make all input able to be read from a screen reader—which is invisible to the course creator.

The publication engine 250 publishes the lesson content in the user requested format. The publication engine 250 presents the publication template 640 to the user devices 125 that direct the user to select a publication format. In one embodiment the user requests that the course be published in a presentation format dictated by the presentations rules. In this case, the publication engine 250 must ensure that it publishes the course material in compliance with the rules. The publication engine 250 analyzes the course material and generates error messages when the it determines the course materials are not in compliance. If the course materials are not in compliance—then the publication engine 250 passes the course material back to the course component creation engine 220 so that it can request corrective input from the course developers. Once there are no errors, the publication engine 250 publishes the course materials that are compliant with the presentation rules. Once the course is published, learner 118 can access the course with the learner device 130.

In one embodiment of course development, course developers use a ‘top-down design’ approach to ensure that multiple users developing an educational course proceed sequentially starting from a commonly agreed upon set of end results. The course development proceeds by levels, and only when users complete one level do they begin developing the next level. When a user edits the top level design after the fact—the developer must also edit the lower levels to correspond with the top level edits.

Using top-down design methodology assists the educator in focusing attention on the course objectives 212 and course outcomes 214. The course objective 212 is a goal to be achieved by a student taking the educational course. For example, in a marketing course, a student objective would be having the ability to analyze how characteristics of a business determine a desired population demographic. Related to course objectives 212 are course outcomes 214, which are skills that demonstrate at least partial achievement of a corresponding course objective 212. For example, in the marketing course, a course outcome 214 related to the course objective 212 above would be a statistical analysis of a current customer base. To create a course model 216, course objectives 212 are mapped to course outcomes 214 using mapping 215.

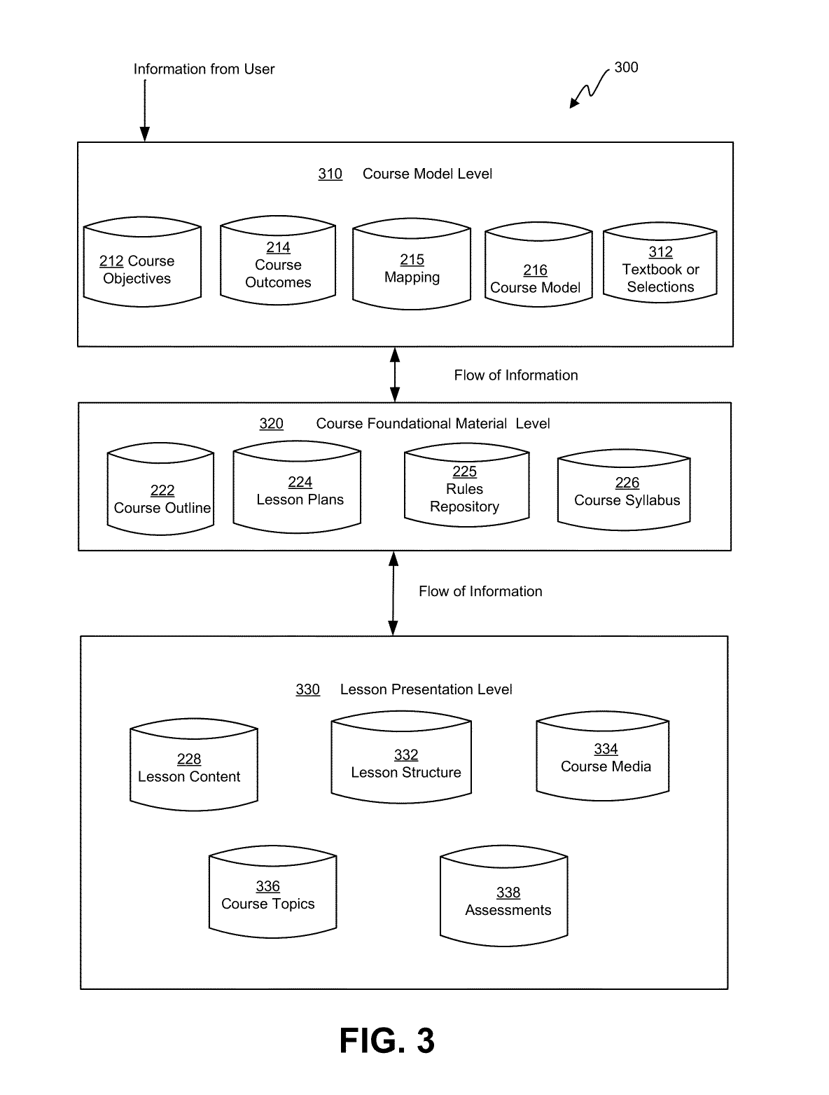

FIG. 3 illustrates an embodiment of a block diagram showing a hierarchy of levels 300 that illustrates various components or information categories of a course organized into three organizational levels 310, 320, 330 by the integrated course design and development system 200 as part of a top-down course design methodology. The embodiment shows only three organizational levels 310, 320, 330, but more or fewer are possible in other embodiments. The number of organizational levels 310, 320, 330 used may depend on the overall difficulty of design of the educational course and ultimate method by which the course is made available to students.

In this embodiment, the organizational levels 310, 320, 330 are arranged from top to bottom according to the importance of the course content categories. The broad themes are in a course model level 310, a course foundational material level 320 in the middle, and a lesson presentation level 330 at the bottom. Having course components or information categories organized into levels aids implementation of top-down design by allowing information entered or edited in a top level category to be incorporated, e.g. by the integrated course design and development system 200, into categories at lower levels and vice versa. Also, the organization assists the course creators in focusing on more important information categories first, which tend to be at the high levels. It is to be noted that information of the various course content categories at lower levels may also be incorporated, if necessary, into categories at higher levels.

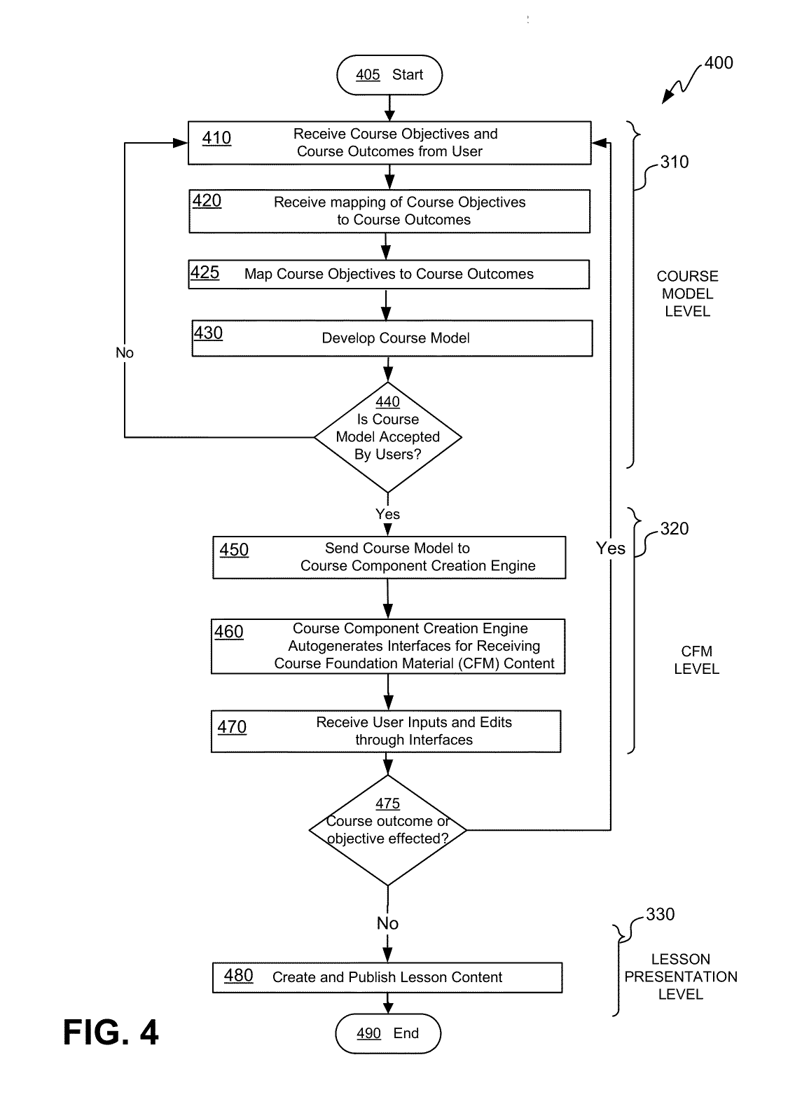

The top-most course model level 310 can be reserved for at least course objectives 212, course outcomes 214, and the mapping 215 that form the basic course model 216. In other embodiments, other course content categories are added or moved into the course model level 310, for example, the course reading material category, textbook or selections 312, is organized to be part of the course model level 310, but could be in the course foundational material level 320 in other embodiments. One or more educators may contribute to any of the organizational levels 310, 320, 330, for example course model level 310. The contributions they enter, such as course outcomes 214, course objectives 212, and mapping 215 may then be used by the course model creation engine 210 to update the course model 216, as explained above in relation to FIG. 2, and below in relation to FIG. 4. Information flows bi-directionally between organizational levels 310, 320, 330 such that manually entered or changed information at one level propagates to the other levels.

When information in the course model level 310 is created and entered even if only for a preliminary draft, the integrated course design and development system 200 updates course information within the course content categories of the next level down. The course foundational material level 320 comprises content categories of course outline 222, lesson plans 224, and Course Syllabus 226. The course foundational material level 320 typically includes course content categories related to details of the course organization and operations, though this is not required.

The course content categories 222, 224, 225, and 226 within the course foundational material level 320 receive information from users to complete those categories. Some of the information entered into a category of the course foundational material level 320 may affect the information in at least one category of the course model level 310. This may occur if an educator realizes that addition of a topic within a lesson plan 224 may involve a supplement to the course outcomes 214. User interfaces provided by the integrated course design and development system 200 to an educator for entry of course content in a category of the course foundational material level 320 may also allow entry for information for a category in the course model level 310. The integrated course design and development system 200 propagates changes within the course model level 310 to automatically update information throughout the course foundational material level 320. This illustrates that while modifications may be made to categories in a higher level even after information is being entered into categories of a lower level, nevertheless the overall top-down design flow is preserved. The course model 216 has all the information from all the levels 310, 320, 330 stored in a relational database as any of the hierarchy of levels 300 is modified.

In the event that the information within the categories of the second level is judged complete, the integrated course design and development system 200 updates course information within the categories of the lesson presentation level 330. The lesson presentation level 330 includes course content categories of lesson presentations 228, lesson structures 332, course media content 334, course topics 336, and assessments 338. The categories at the lesson presentation level 330 typically relate to the specific subject matter of the course, though this is not necessarily required. As discussed above, information from the course model level 310 and course foundational material level 320 are used to update and/or modify the information within categories of the lesson presentation level 330 in order to implement top-down design flow.

Referring next to FIG. 4, a flow chart illustrates steps of a method 400 for interactively developing an educational course using top-down design flow, according to an embodiment of the invention. The steps of the method implement the levels 310, 320, 330 of the course content categories discussed in relation to FIG. 3.

After starting at step 405, at step 410, the course objectives 212 and course outcomes 214 are received from a course creator or educator. The information received may be related to the course objectives 212 and course outcomes 214 from multiple educators. In one embodiment, the user enters information through a user interface on an electronic device. The user may have accessed the content specific user interface 117 through the integrated course design and development system 200.

At the next step 420, the mapping 214 of the course objectives 212 to the course outcomes 214 is received from the user. At the next step 425, the course objective 212 are mapped to the course outcomes 214. That mapping can be based, for example, on how important a particular course objective 212 is to the achieving the course outcome 214. Alternatively, the mapping may be based on mapping information, e.g. importance correlation information, received from the educators.

At step 430, the integrated course design and development system 200 generates a course model 216 using the course objectives 212, the course outcomes 214, and the provided mapping information. The course model 216 may comprise relationships between the various course content categories, of any level 310, 320, 330, discussed in relation to FIG. 3. Performing steps 410, 420 and 430 first ensures that the top-level information in the categories of all levels is incorporated into the course model 216. The course model 216 may be implemented using a database, a relational database or a hierarchically arranged relational database. Other methods for maintaining relationships and interconnections, such as trees, graphs or multidimensional cell structures, may also be used in various embodiments.

At step 440, education and other users can review the course model 216. If the course model 216 is not deemed satisfactory for the educational course, the educators may update or revise the course objectives 212, course outcomes 214, and the mapping 215 to generate a revised course model 216 by returning to step 410. Otherwise, the course model 216 is used by the integrated course design and development system 200 to update and provide information for course content categories of other levels 310, 320, 330.

At steps 450 and 460, the course component and creation engine 220 uses the course model 216 to auto-generate content specific user interfaces 117, at least in part, to be used by educators to submit content for categories in the course foundational materials level 320. The auto-generation populates the content specific user interfaces 117, and some of the content of the categories, based on the course model 216.

At step 470, the inputs and edits from an educator are received through the content specific user interfaces 117. At step 475 if the inputs cause a need to modify the course objectives 212 or the course outcomes 214 and affected mapping 215, then the next step will be at 410 to receive new input and the process will begin from that point.

Alternatively, if the inputs and edits at step 470 do not cause a need to modify the course objectives 212 or the course outcomes 214, the inputs and edits can be entered into the appropriate category of the course foundational material level 320.

At step 480, the lesson content is created according to the presentation rules and published in a format in compliance with the presentation rules. Step 499 is the end.

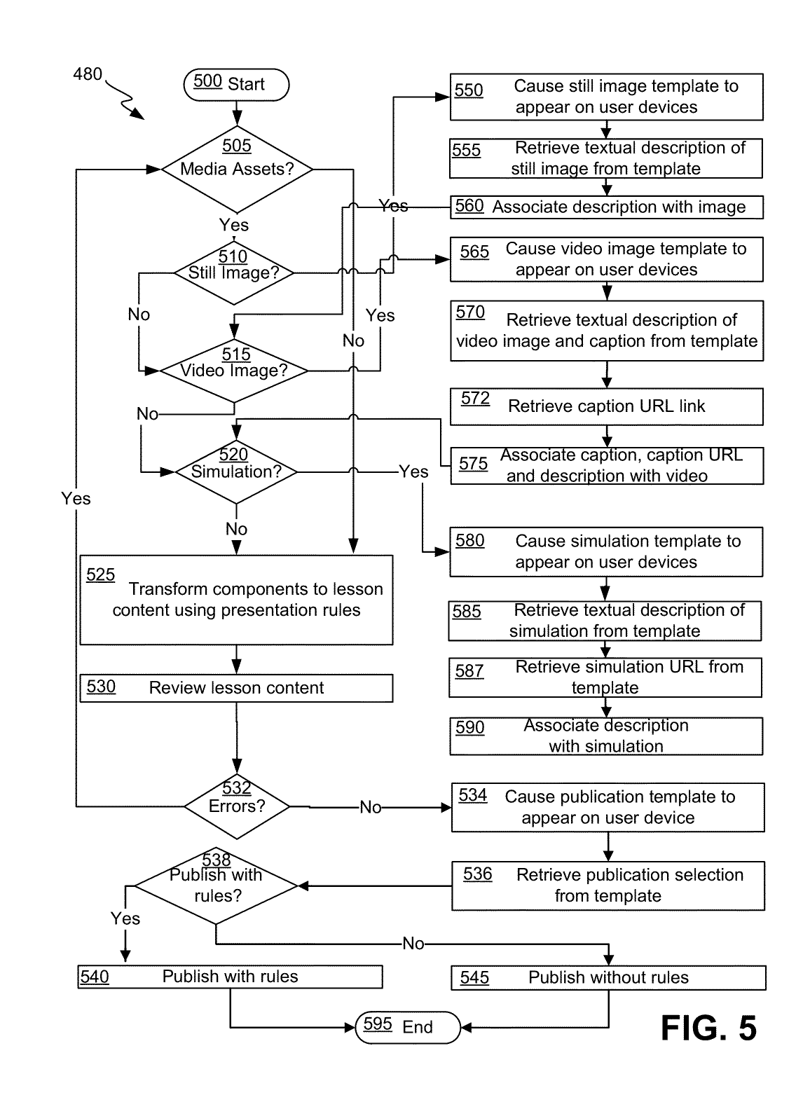

Referring next to FIG. 5, a flowchart of method step 480, create and publish lesson content. Step 500 is the starting point. Next,step 505 checks to see if the course material contains media assets. If a course contains medial asset such as still images, video images, and/or simulations—additional steps are necessary to add textual information so that a learner need not see the images or simulation to be able to fully understand what it is conveying. If the course material does not have media assets—there is no need to perform these additional steps so they are skipped and the next step is 525. If there are media assets then the next step 510 determines if any of the media assets are one or more still images. If there are not—then step 515 is next, but if there are one or more still images then the next step 550 causes a still image template 620 to appear on user devices 125 that directs the user to input a description(s) of the image(s). The method retrieves the textual description of the still image from the still image template 620 at step 555. At step 560 the description(s) are associated with the still image(s). In this manner—a course learner will hear the description of the still image when it occurs in the course. The next step 515 assesses whether the course material contains one or more video images. If it does not—then it proceeds to step 520. If the course material does contain one or more video images the next step 565 causes a video image template 625 to appear on user devices 125 that direct the user to input description(s) of the video image(s) and to enter caption(s) for the video(s). The video image descriptions and the video image captions are retrieved from the video image template 625 at step 570. At step 572 the caption(s) URL link(s) are retrieved from the video image template 625 and then are attached to the video images during publication. At step 575 the description(s) and the caption(s) and/or caption URL(s) are associated with the video image(s). In this case—a course learner can read the description and captions without needing the associated audio. Step 520 determines if the course material contains any simulations and proceeds to step 525 if there are none. If there are one or more simulations in the course material step 580 presents the simulation template 630 to the user devices 125 and directs the user to input a complete description for each simulation. Step 585 is retrieving the description from the simulation template 630. Step 587 is retrieving the location of the simulation URL(s) from the simulation template 630. At step 590 the description(s) and simulation URL(s) are associated with the simulations(s). In this scenario—a course learner need only to listen to description without having to view the simulation.

At step 525 all of the course materials text is transformed to lesson content in a format in compliance with the presentation rules. In one embodiment Section 508 rules require that text be converted to screen reader format. A screen reader is most often a software application running on a computing device that presents the information on the screen to the user in an audible format. Commonly available examples of software application based screens readers comprise Microsoft Narrator, Apple VoiceOver, Google Text-To-Speech, Orca, JAWS, and Window-Eyes, but there are many others. Screen readers can also output to devices such as a Braille output device. Step 530 reviews the course lesson content to make sure that it complies with the presentation rules. If errors are found at step 532 the process begins again at step 505. If no errors are found step 534 presents the publication template 640 to user devices 125 directing the user to select a publication method. At step 536 the selection is retrieved from publication template 640. If the selection indicate that the lesson content should be published in compliance with the presentation rules it is published in compliance with the presentation rules at step 540 and if there are caption URLs they are linked during publication. If the compliance rules are Section 508 then the lesson content must be published to meet the criteria in the Criteria table previously identified. If not, the course lesson content is published not in compliance with the presentations rules at step 545. At this point the lesson content is available to learner 118 on learner device 130 in its final form. Step 595 is the end.

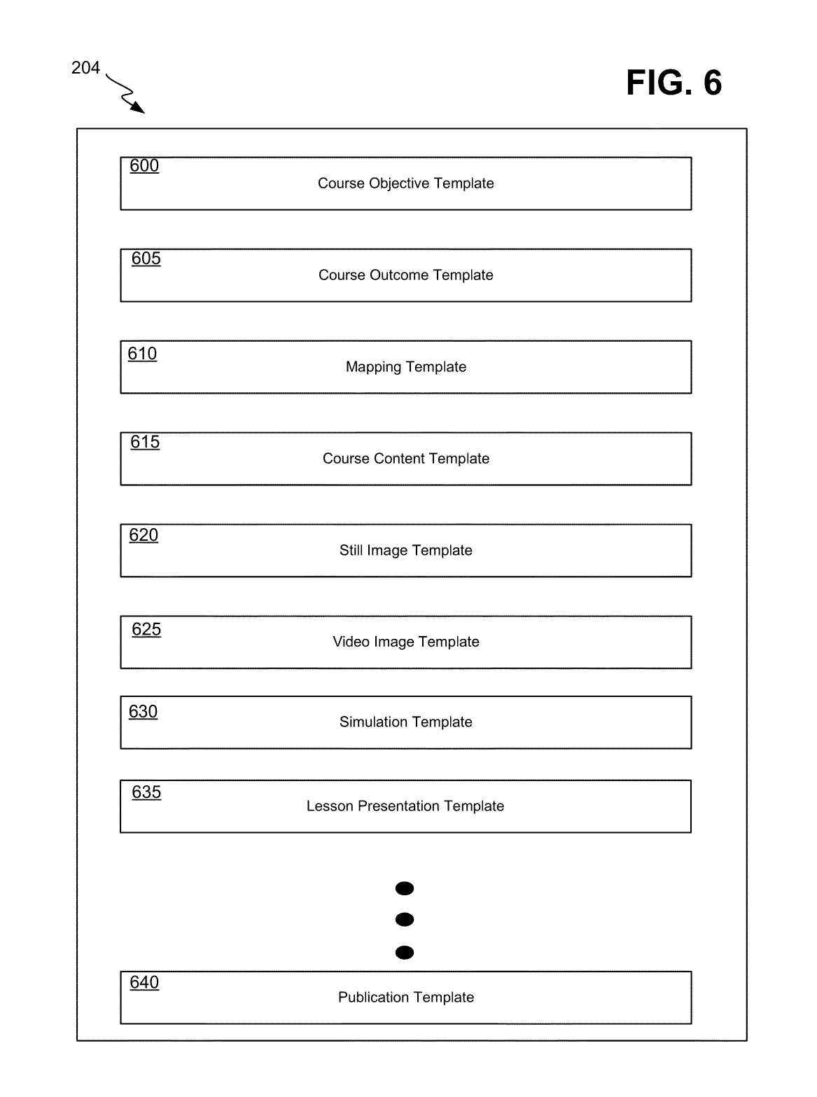

FIG. 6 depicts some of the templates available in the templates 204 repository. Templates are the key to automated course creation in some embodiments. They allow multiple users to input course material in a consistently and simultaneous manner. Course objective template 600 is a template presented to user devices 125 so that users can enter the course objectives 212 for the course under development. The template format ensures that every user enters course objective in an consistent manner. Course outcome template 605 is format for entering desired course outcomes 214. Mapping template 610 creates a way to associate the course outcomes 214 with the course objectives 212 and this association forms the base for the course model 216. Course content template 615 presents the way that users should enter the general course content so that course can be created automatically when all users have finished entering the general course content.

In some embodiments, still image template 620 is used when implementing Section 508 accessibility rules. The still image template 620 is presented on the user devices 125 and directs the user to input a textual description of the still image. The textual description is associated with the image and ultimately transformed to be compatible with a screen reader. In this manner, a visually impaired learner 118, or a learner 118 who wishes to access course content audibly can get the full experience of the lesson content without needing to view the still images. The description can be added as an HTML attribute using “Alt text.” Similarly, video image template 625 accomplishes the same result for video images. The video image template 625 presented on the user device directs the user to input a textual description of the video image as well as textual captions describing the actions taking place in the video image. Again—a visually impaired learner 118 or a learner 118 who wishes to access course content audibly will get the full experience of the lesson content with a screen reader. Furthermore, an audibly impaired learner 118 or a learner that only wishes to view the course without audio can get the full experience as well from reading the captions. Simulation template 630 accomplishes this same goal for simulations in the course material. The simulation template 630 is presented to the user devices 125 prompting the user to give a comprehensive textual description of what is happening in the simulation. For instance, if the simulation is graphically showing the compounding effect of an interest rate on a lump sum deposit over a period of 10 years—the textual description must describe the graphical presentation. In another case—if the simulation is showing the rate of filling a container under different pressures—the textural description must describe that process in enough detail so that a learner 118 listening to the course can understand the simulation without viewing it.

Lesson presentation template 635 provides a template for how the lesson is to be presented and may comprise one or more options. When the lesson content is complete, publication template 640 is presented to the user devices 125 with directions to select a publication forma. In some embodiments the user can select to publish the lesson content according to the presentation rules. In the case that the user selects to publish the lesson content in compliance with the Section 508 accessibility rules, learners 118 with disabilities will be able to take the course and get the course experience that all other learners 118 receive. The templates depicted in FIG. 6 are not a comprehensive list of templates used for automated course generation, and one of ordinary skill in that art will know that many, many templates for various purposes are used.

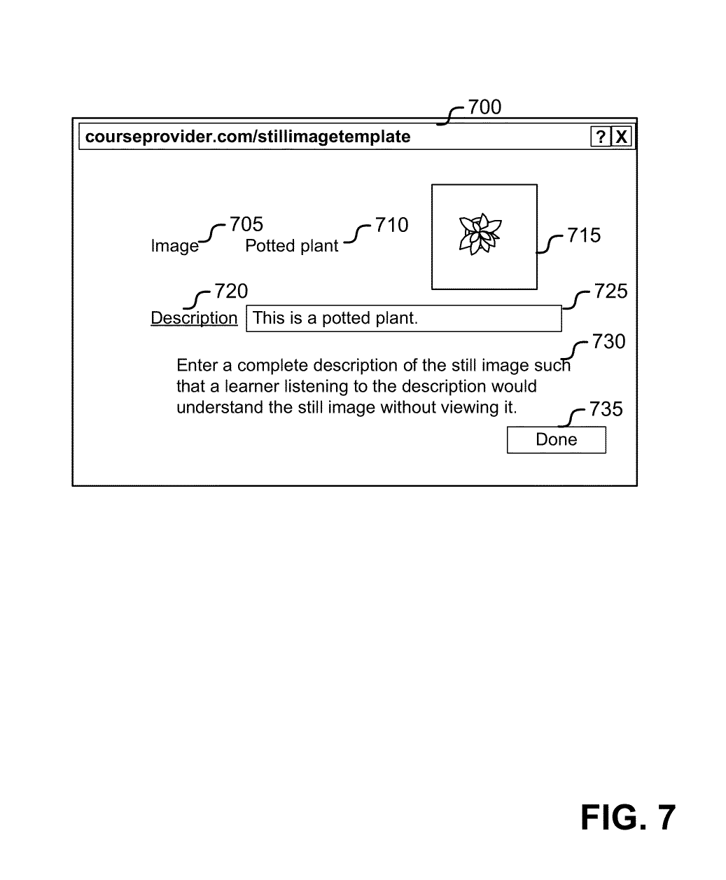

FIG. 7 depicts an example of a screen shot of the still image template 620. The screen shot shows the title bar 700 indicating that the template is the still image template. Image 705 is an indication for the title of the image show in 710 as a potted plant. The image 715 shows a potted plant. 720 is the request for the type of input required—in this case a description. The input field 725 has an example input for the potted plant. 730 is a further explanation of what should be entered into the input field 725. 735 is a button indicating that input on the still image template 620 is done.

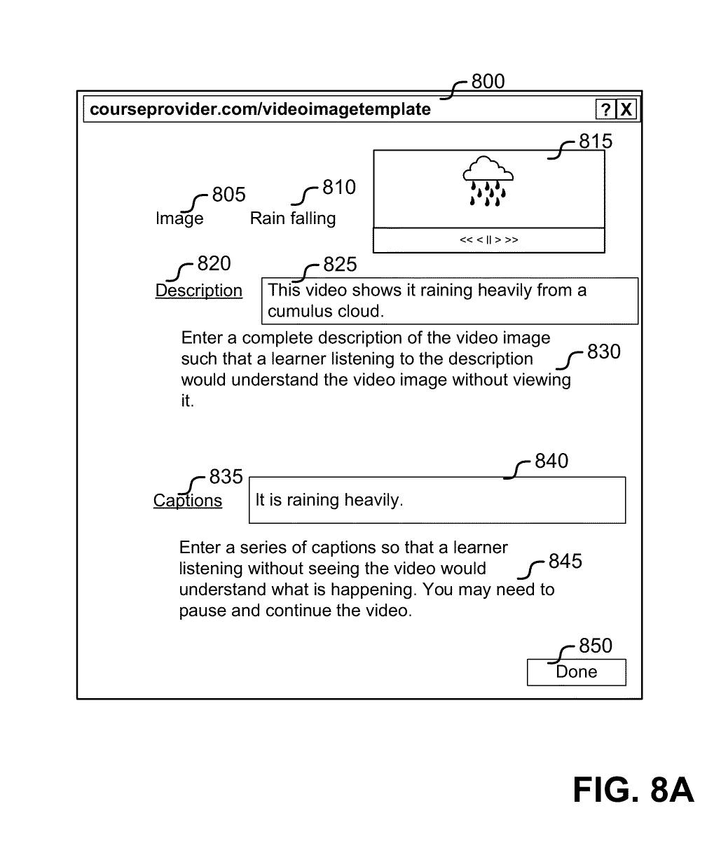

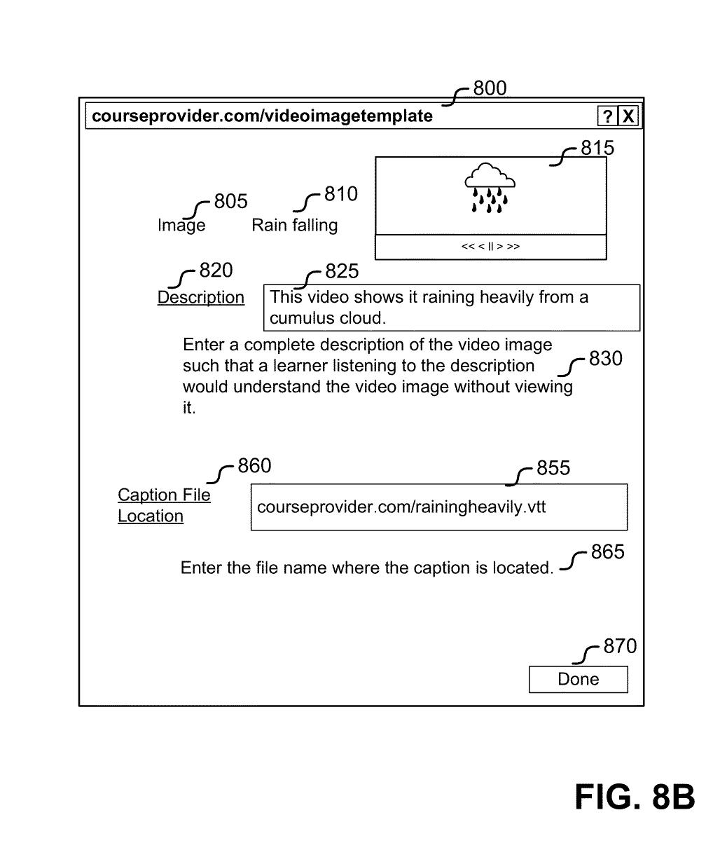

FIG. 8A depicts an example of a screen shot of the video image template 625. The screen shot shows the title bar 800 indicating that the template is the video image template. Image 805 is an indication for the title of the video image 810 as rain falling. The video image 815 shows a video image depicting rain falling in an image player with control buttons. 820 is the request for the type of input required—in this case a description. The input field 825 has an example input rain falling from a cumulus cloud. 830 is a further explanation of what should be entered into the input field 825. 835 is the request for a type of input—in this case textural captions. The input field 840 shows a caption that indicates the video image is showing heavy rainfall. 840 is a further explanation of what should be entered in input field 840. 850 is a button indicating that input on the video image template 625 is complete. 860 is the request for a type of input—in this case textural captions. The input field 840 shows a caption that indicates the video image is showing heavy rainfall. 840 is a further explanation of what should be entered in input field 840. 850 is a button indicating that input on the video image template 625 is complete.

FIG. 8B depicts an example of a screen shot of the video image template 625. The screen shot shows the title bar 800 indicating that the template is the video image template. Image 805 is an indication for the title of the video image 810 as rain falling. The video image 815 shows a video image depicting rain falling in an image player with control buttons. 820 is the request for the type of input required—in this case a description. The input field 825 has an example input rain falling from a cumulus cloud. 830 is a further explanation of what should be entered into the input field 825. 860 is the request for a type of input—in this case the file location where the captions can be found that will be included when the course is published. The input field 855 shows a file name where the “raining heavily caption can be found. 865 is the explanation for that input telling the user to enter the files name. 870 is the button indicating the user is done entering input into this template.

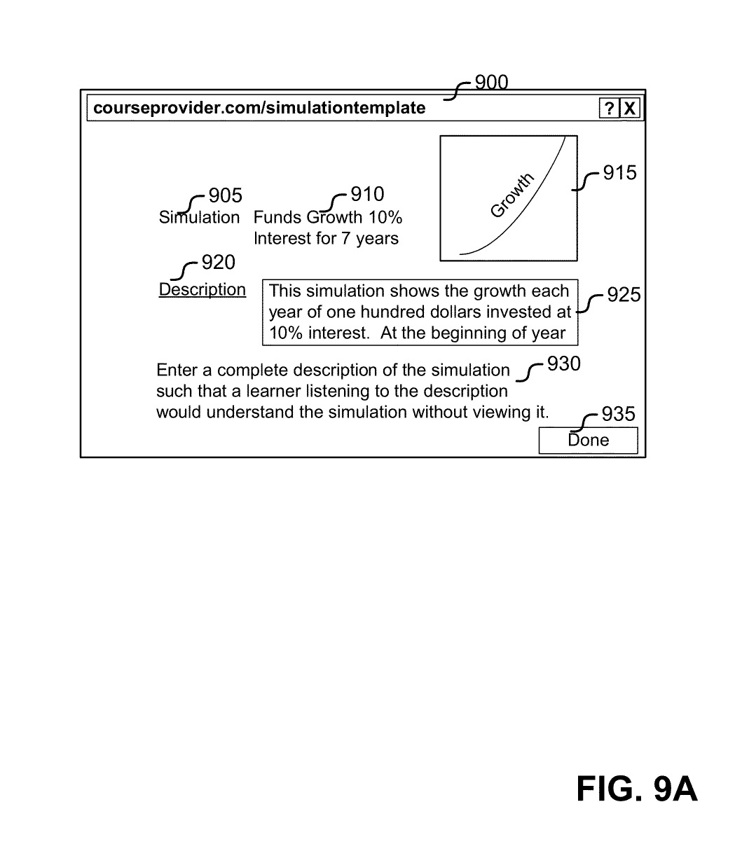

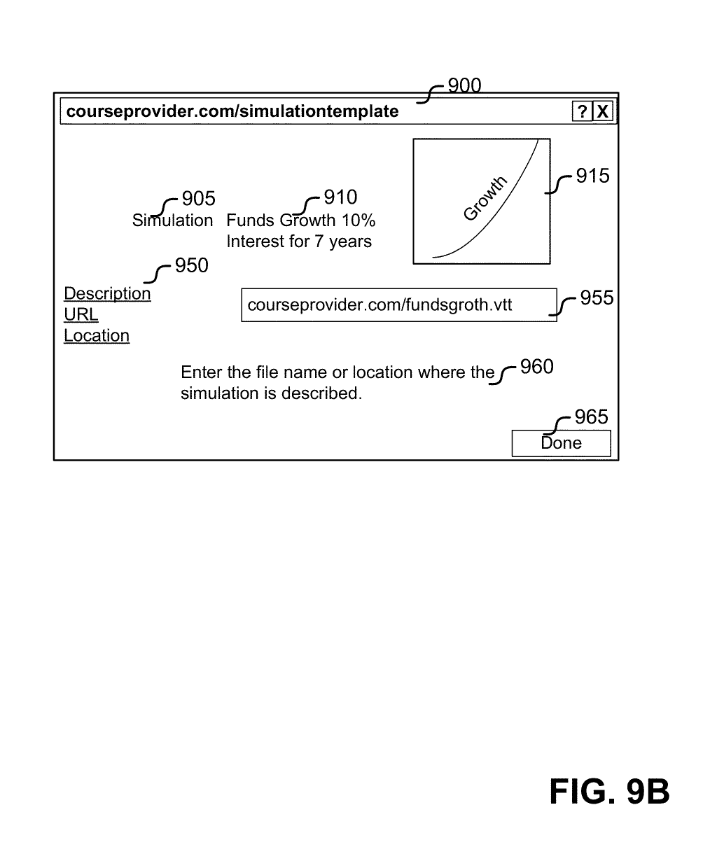

FIG. 9A depicts an example of a screen shot of the simulation template 630. The screen shot shows the title bar 900 indicating that the template is the simulation template. Image 905 is an indication for the title of the simulation show in 910—funds growth. The simulation 915 shows a graphical line going up each year. 920 is the request for the type of input required—in this case a description. The input field 925 has an explanation of what happens each year in the graph. 930 is a further explanation of what should be entered into the input field 925. 935 is a button indicating that input on the simulation template 630 is done.

FIG. 9B depicts another example of a screen shot of the simulation template 630. The screen shot shows the title bar 900 indicating that the template is the simulation template. Image 905 is an indication for the title of the simulation show in 910—funds growth. The simulation 915 shows a graphical line going up each year. 950 is the request for the type of input required—in this case the location of the simulation URL. The input field 955 contains the location. 960 is a further explanation of what should be entered into the input field 955. 965 is a button indicating that input on the simulation template 630 is done.

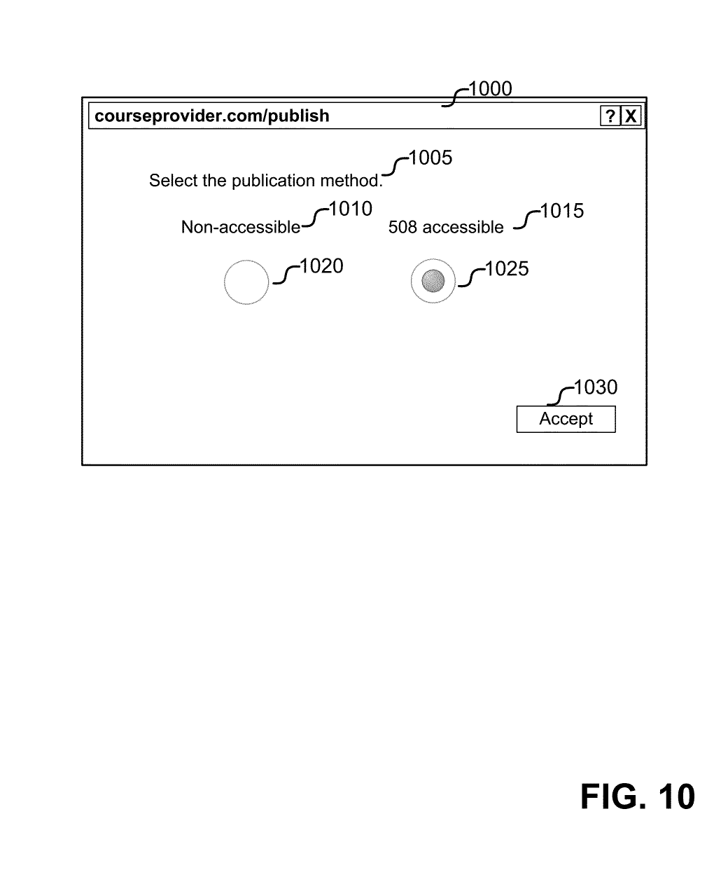

FIG. 10 depicts an example of a screen shot of the publication template 640. The screen shot shows the title bar 1000 indicating that the template is the publication template. Image 1005 is the request to select a publication method of non-accessible 1010 or accessible 1015. The radio button 1020 is not selected. The radio button 1025 is shown as selected to indicate 508 accessible publication. 1030 is a button asking the user to accept the publication selection.

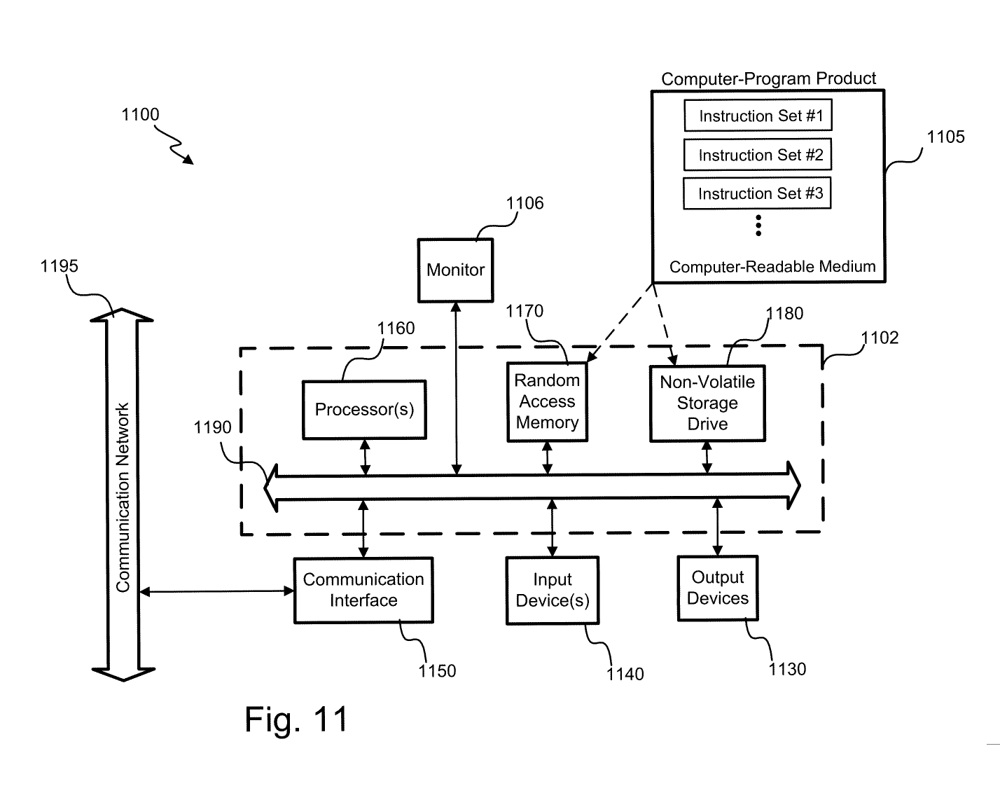

FIG. 11 shows an embodiment of a computer system 1100 capable of implementing one or more of the methods disclosed above. For example, one or more special-purpose computer systems 1100 can be used to provide the instructional design and development system 200. The above methods can be implemented by means of a computer-program product 1105 that direct a computer system to perform the actions of the above-described methods and components. Each such computer-program product can comprise sets of instructions (codes) embodied on a computer-readable medium that directs the processor of the computer system to perform corresponding actions. The instructions can be configured to run in sequential order, or in parallel (such as under different processing threads), or in a combination thereof. The computer-program products can be loaded into the computer system 1102.

The computer system 1100 may comprise a monitor 1106, one or more additional user output devices 1140, one or more user input devices 1140 (e.g., keyboard, mouse, track ball, touch screen) coupled to a main computing subsystem 1102, an optional communications interface 1150 coupled to the computing subsystem 1102, a computer-program product 1105 stored in a tangible computer-readable memory in computer subsystem 1102. Computer-program product 1105 directs system 1100 to perform the above-described methods. Computing subsystem 1102 can include one or more processors 1160 that communicate with a number of peripheral devices via a bus subsystem 1190. These peripheral devices can include user output device(s) 1140, user input device(s) 1140, communications interface 1150, and a storage subsystem, such as random access memory (RAM) 1170 and non-volatile storage drive 1180 (e.g., disk drive, optical drive, solid state drive), which are forms of tangible computer-readable memory.

Computer-program product 1105 can be stored in non-volatile storage drive 1190 or another computer-readable medium accessible to computing subsystem 1102 and loaded into memory 1170. Each processor 1160 can comprise a microprocessor, such as a microprocessor from Intel® or Advanced Micro Devices, Inc®, Qualcomm or the like. To support computer-program product 1105, the computing subsystem 1102 runs an operating system that handles the communications of product 1105 with the above-noted components, as well as the communications between the above-noted components in support of the computer-program product 1105. Exemplary operating systems include Apple's iOS and various other operating systems, Google's Chrome and Android, Windows® or the like from Microsoft Corporation, Solaris® from Sun Microsystems, LINUX, UNIX, and the like.

User input devices 1140 include all possible types of devices and mechanisms to input information to computing subsystem 1102. These can include a keyboard, a keypad, a mouse, a scanner, a digital drawing pad, a touch screen incorporated into the display, audio input devices such as voice recognition systems, microphones, and other types of input devices. In various embodiments, user input devices 1140 are typically embodied as a computer mouse, a trackball, a track pad, a joystick, wireless remote, a drawing tablet, a voice command system. User input devices 1140 typically allow a user to select objects, icons, text and the like that appear on the monitor 1106 via a command such as a click of a button or the like. User output devices 1130 include all possible types of devices and mechanisms to output information from computing subsystem 1102. These can include a display (e.g., monitor 1106), printers, non-visual displays such as audio output devices, etc.

Communications interface 1150 provides an interface to other communication networks and devices and can serve as an interface to receive data from and transmit data to other systems, WANs and/or the Internet 1195. Embodiments of communications interface 1150 typically include an Ethernet card, a modem (telephone, satellite, cable, ISDN), a (asynchronous) digital subscriber line (DSL) unit, a FireWire® interface, a USB® interface, a wireless network adapter, and the like. For example, communications interface 1150 can be coupled to a computer network, to a FireWire® bus, or the like. In other embodiments, communications interface 1150 can be physically integrated on the motherboard of computing subsystem 1102, and/or can be a software program, or the like.

RAM 1170 and non-volatile storage drive 1180 are examples of tangible computer-readable media configured to store data such as computer-program product embodiments of the present invention, including executable computer code, human-readable code, or the like. Other types of tangible computer-readable media include floppy disks, removable hard disks, optical storage media such as CD-ROMs, DVDs, bar codes, semiconductor memories such as flash memories, read-only-memories (ROMs), battery-backed volatile memories, networked storage devices, and the like. RAM 1170 and non-volatile storage drive 1180 can be configured to store the basic programming and data constructs that provide the functionality of various embodiments of the present invention, as described above.

Software instruction sets that provide the functionality of the present invention can be stored in RAM 1170 and non-volatile storage drive 1180. These instruction sets or code can be executed by processor(s) 1160. RAM 1170 and non-volatile storage drive 1180 can also provide a repository to store data and data structures used in accordance with the present invention. RAM 1170 and non-volatile storage drive 1180 can include a number of memories including a main random access memory (RAM) to store of instructions and data during program execution and a read-only memory (ROM) in which fixed instructions are stored. RAM 1170 and non-volatile storage drive 1180 can include a file storage subsystem providing persistent (non-volatile) storage of program and/or data files. RAM 1170 and non-volatile storage drive 1180 can also include removable storage systems, such as removable flash memory.

Bus subsystem 1190 provides a mechanism to allow the various components and subsystems of computing subsystem 1102 communicate with each other as intended. Although bus subsystem 1190 is shown schematically as a single bus, alternative embodiments of the bus subsystem can utilize multiple busses or communication paths within computer 1100.

Specific details are given in the above description to provide a thorough understanding of the embodiments. However, it is understood that the embodiments can be practiced without these specific details. For example, circuits can be shown in block diagrams in order not to obscure the embodiments in unnecessary detail. In other instances, well-known circuits, processes, algorithms, structures, and techniques can be shown without unnecessary detail in order to avoid obscuring the embodiments.

Implementation of the techniques, blocks, steps and means described above can be done in various ways. For example, these techniques, blocks, steps and means can be implemented in hardware, software, or a combination thereof. For a hardware implementation, the processing units can be implemented within one or more application specific integrated circuits (ASICs), digital signal processors (DSPs), digital signal processing devices (DSPDs), programmable logic devices (PLDs), field programmable gate arrays (FPGAs), processors, controllers, micro-controllers, microprocessors, other electronic units designed to perform the functions described above, and/or a combination thereof.

Also, it is noted that the embodiments can be described as a process which is depicted as a flowchart, a flow diagram, a data flow diagram, a structure diagram, or a block diagram. Although a flowchart can describe the operations as a sequential process, many of the operations can be performed in parallel or concurrently. In addition, the order of the operations can be re-arranged. A process is terminated when its operations are completed, but could have additional steps not included in the figure. A process can correspond to a method, a function, a procedure, a subroutine, a subprogram, etc. When a process corresponds to a function, its termination corresponds to a return of the function to the calling function or the main function.

Furthermore, embodiments can be implemented by hardware, software, scripting languages, firmware, middleware, microcode, hardware description languages, and/or any combination thereof. When implemented in software, firmware, middleware, scripting language, and/or microcode, the program code or code segments to perform the necessary tasks can be stored in a machine readable medium such as a storage medium. A code segment or machine-executable instruction can represent a procedure, a function, a subprogram, a program, a routine, a subroutine, a module, a software package, a script, a class, or any combination of instructions, data structures, and/or program statements. A code segment can be coupled to another code segment or a hardware circuit by passing and/or receiving information, data, arguments, parameters, and/or memory contents. Information, arguments, parameters, data, etc. can be passed, forwarded, or transmitted via any suitable means including memory sharing, message passing, ticket passing, network transmission, etc.

For a firmware and/or software implementation, the methodologies can be implemented with modules (e.g., procedures, functions, and so on) that perform the functions described herein. Any machine-readable medium tangibly embodying instructions can be used in implementing the methodologies described herein. For example, software codes can be stored in a memory. Memory can be implemented within the processor or external to the processor. As used herein the term “memory” refers to any type of long term, short term, volatile, nonvolatile, or other storage medium and is not to be limited to any particular type of memory or number of memories, or type of media upon which memory is stored.

Moreover, as disclosed herein, the term “storage medium” can represent one or more memories for storing data, including read only memory (ROM), random access memory (RAM), magnetic RAM, core memory, magnetic disk storage mediums, optical storage mediums, flash memory devices and/or other machine readable mediums for storing information. The term “machine-readable medium” includes, but is not limited to portable or fixed storage devices, optical storage devices, wireless channels, and/or various other storage mediums capable of storing that contain or carry instruction(s) and/or data.

While the principles of the disclosure have been described above in connection with specific apparatuses and methods, it is to be clearly understood that this description is made only by way of example and not as limitation on the scope of the disclosure.

What is claimed is:

1. A method of electronically creating a digital education course in compliance with presentation rules, the method comprising:
receiving the presentation rules from user devices;
receiving course components from the user devices;
determining there is a still image within the course components,
causing a still image template to appear on the user devices,
retrieving a first textual description of the still image from the still image template, and
associating the first textural description of the still image with the still image; and
determining there is a video image within the course components,
causing a video image template to appear on the user devices,
retrieving a second textual description of the video image from the video image template,
retrieving textual captions for the video image from the video image template, and
associating the second textural description of the video image and the textual captions of the video image with the video image; and
determining there is a simulation within the course components,
causing a simulation template to appear on the user devices,
retrieving a third textual description of the simulation from the simulation template, and
associating the third textural description of the simulation with the simulation; and
transforming the course components to create lesson content using the presentation rules;
causing a publication template to appear on the user devices;
retrieving from the publication template a publication selection to publish the lesson content in accordance with the presentation rules; and
publishing the lesson content in accordance with the presentation rules.

2. A method of electronically creating a digital education course in compliance with presentation rules according to claim 1 wherein the presentation rules comprise accessibility rules.

3. A method of electronically creating a digital education course in compliance with presentation rules according to claim 2 wherein the accessibility rules comply with Section 508.

4. A method of electronically creating a digital education course in compliance with presentation rules according to claim 1 wherein the presentation rules require the lesson content to be in a foreign language.

5. A method of electronically creating a digital education course in compliance with presentation rules according to claim 4 wherein the foreign language is Spanish, French, German, Russian, Arabic, Japanese, Chinese, or Indian.

6. A method of electronically creating a digital education course in compliance with presentation rules according to claim 1 wherein the presentation rules prohibit the use of selected words and/or phrases.

7. A method of electronically creating a digital education course in compliance with presentation rules according to claim 1 wherein the presentation rules prohibit the use of selected still and/or video images.

8. A processor with computer-readable medium having executable instructions for electronically creating a digital education course in compliance with presentation rules, the processor comprising executable instructions for:
receiving the presentation rules from user devices;
receiving course components from the user devices;
determining there is a still image within the course components,
causing a still image template to appear on the user devices,
retrieving a first textual description of the still image from the still image template, and
associating the first textural description of the still image with the still image; and
determining there is a video image within the course components,
causing a video image template to appear on the user devices,
retrieving a second textual description of the video image from the video image template,
retrieving textual captions for the video image from the video image template, and
associating the second textural description of the video image and the textual captions of the video image with the video image; and
determining there is a simulation within the course components,
causing a simulation template to appear on the user devices,
retrieving a third textual description of the simulation from the simulation template, and
associating the third textural description of the simulation with the simulation; and
transforming the course components to create lesson content using the presentation rules;
causing a publication template to appear on the user devices;
retrieving from the publication template a publication selection to publish the lesson content in accordance with the presentation rules; and
publishing the lesson content in accordance with the presentation rules.

9. A processor with computer-readable medium having executable instructions for electronically creating a digital education course in compliance with presentation rules according to claim 8 wherein the presentation rules comprise accessibility rules.

10. A processor with computer-readable medium having executable instructions for electronically creating a digital education course in compliance with presentation rules according to claim 9 wherein the accessibility rules comply with Section 508.

11. A processor with computer-readable medium having executable instructions for electronically creating a digital education course in compliance with presentation rules according to claim 8 wherein the presentation rules require the lesson content to be in a foreign language.

12. A processor with computer-readable medium having executable instructions for electronically creating a digital education course in compliance with presentation rules according to claim 11 wherein the foreign language is Spanish, French, German, Russian, Arabic, Japanese, Chinese, or Indian.

13. A processor with computer-readable medium having executable instructions for electronically creating a digital education course in compliance with presentation rules according to claim 8 wherein the presentation rules prohibit the use of selected words and/or phrases.

14. A processor with computer-readable medium having executable instructions for electronically creating a digital education course in compliance with presentation rules according to claim 8 wherein the presentation rules prohibit the use of selected still and/or video images.

15. A system for electronically creating a digital education course in compliance with presentation rules, the system configured to:
receive the presentation rules from user devices;
receive course components from the user devices;
determine there is a still image within the course components,
cause a still image template to appear on the user devices,
retrieve a first textual description of the still image from the still image template, and
associate the first textural description of the still image with the still image; and
determine there is a video image within the course components,
cause a video image template to appear on the user devices,
retrieve a second textual description of the video image from the video image template,
retrieve textual captions for the video image from the video image template, and
associate the second textural description of the video image and the textual captions of the video image with the video image; and
determine there is a simulation within the course components,
cause a simulation template to appear on the user devices,
retrieve a third textual description of the simulation from the simulation template, and
associate the third textural description of the simulation with the simulation; and
transform the course components to create lesson content using the presentation rules;
cause a publication template to appear on the user devices;
retrieve from the publication template a publication selection to publish the lesson content in accordance with the presentation rules; and
publish the lesson content in accordance with the presentation rules.

16. A system for electronically creating a digital education course in compliance with presentation rules according to claim 15 wherein the presentation rules comprise accessibility rules.

17. A system for electronically creating a digital education course in compliance with presentation rules according to claim 16 wherein the accessibility rules comply with Section 508.

18. A system for electronically creating a digital education course in compliance with presentation rules according to claim 15 wherein the presentation rules require the lesson content to be in a foreign language.

19. A system for electronically creating a digital education course in compliance with presentation rules according to claim 18 wherein the foreign language is Spanish, French, German, Russian, Arabic, Japanese, Chinese, or Indian.

20. A system for electronically creating a digital education course in compliance with presentation rules according to claim 15 wherein the presentation rules prohibit the use of selected words and/or phrases.
